(19) United States
(12) Patent Application Publication
(10) Pub. No.: US 2026/0080068 A1
(43) Pub. Date: Mar. 19, 2026

(54) THREAT ACTOR INFRASTRUCTURE PROFILING USING A GRAPH AND REPUTATION PROPAGATION

(71) Applicant: Microsoft Technology Licensing, LLC, Redmond, WA (US)

(72) Inventors: Scott Alexander FREITAS, Phoenix, AZ (US); Amirhossein GHARIB, Toronto (CA)

(21) Appl. No.: 18/942,241

(22) Filed: Nov. 8, 2024

Related U.S. Application Data
(60) Provisional application No. 63/695,837, filed on Sep. 17, 2024.

(51) Int. Cl. G06F 21/57

(52) U.S. Cl. CPC G06F 21/577; G06F 2221/034

(57) ABSTRACT

A computerized method performs threat actor infrastructure profiling using a graph and a reputation propagation algorithm. A threat intelligence (TI) graph comprising known entities and unknown entities is created based on relationships in telemetry data. Risk scores for the known entities in the TI graph are initialized from a TI database. One or more of the unknown entities are classified using a reputation propagation algorithm based on relationships of the unknown entities with the known entities, and the risk scores for the known entities in the TI graph. A remediation action for the classified unknown entities is recommended. In some examples, the remediation action is automatically initiated for the classified unknown entities and the TI graph is updated in response to the remediation action.

### CROSS-REFERENCE TO RELATED APPLICATION

This application claims priority to U.S. Provisional Patent Application No. 63/695,837, entitled “THREAT ACTOR INFRASTRUCTURE PROFILING USING A GRAPH AND REPUTATION PROPAGATION,” filed on Sep. 17, 2024, the disclosure of which is incorporated herein by reference in its entirety.

### BACKGROUND

Cybersecurity threats have evolved significantly in recent years, with attackers leveraging increasingly sophisticated techniques to compromise computer systems, networks, and data. These cyber threats are frequently carried out by threat actors who use a variety of malicious infrastructures, such as IP addresses, files domain names, servers, and other network elements, to conduct their activities. Traditional cybersecurity methods often focus on identifying and neutralizing individual threats, such as malware or phishing attacks, but may overlook the broader infrastructure that enables these attacks. Tracking and profiling these infrastructures and their interrelationships is crucial for cybersecurity professionals to understand, mitigate, and prevent future attacks.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and computerized method for threat actor infrastructure profiling using a graph and a reputation propagation algorithm are provided. A threat intelligence (TI) graph comprising known entities and unknown entities is created based on relationships in telemetry data obtained from a database. Risk scores for the known entities in the TI graph are initialized from a TI database. One or more of the unknown entities are classified using a reputation propagation algorithm based on relationships of the unknown entities with the known entities, and the risk scores for the known entities in the TI graph. A remediation action for the classified unknown entities is recommended. In some examples, the remediation action is automatically initiated for the classified unknown entities and the TI graph is updated in response to the remediation action.

### BRIEF DESCRIPTION OF THE DRAWINGS

The present description will be better understood from the following detailed description read considering the accompanying drawings, wherein:

FIG. 1 is a block diagram illustrating an example system to generate artificial intelligence (AI) infused threat actor infrastructure profiling (TAIP);

FIG. 2A is a diagram illustrating an architectural overview of an example AI-TAIP framework in a single geographic region;

FIG. 2B illustrates an example of an early disruption and TI generation architecture through cross-organization TAIP;

FIG. 3 illustrates a comparison of an initial distribution of risk scores assigned to entities, prior to any reputation propagation and a distribution of predicted risk scores using label propagation algorithm;

FIG. 4 is a flowchart illustrating an example method for generating AI infused threat infrastructure profiling; and

FIG. 5 illustrates an example computing apparatus as a functional block diagram.

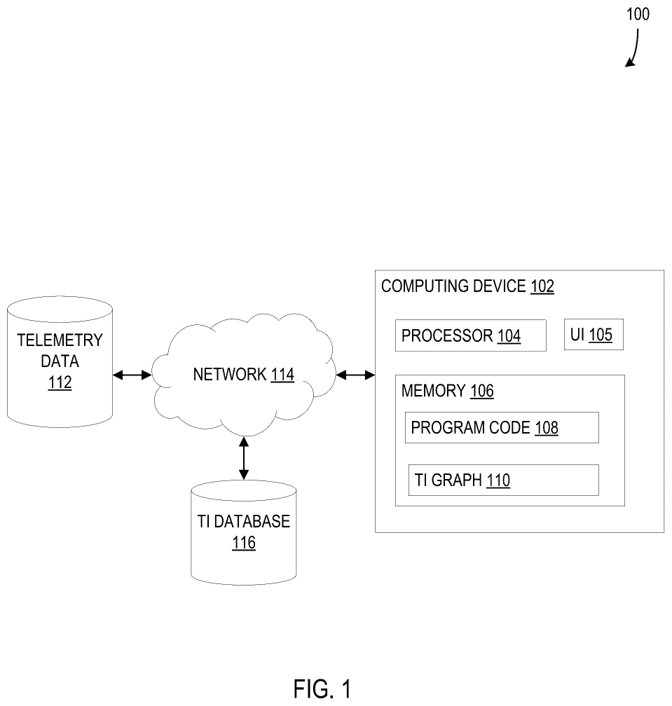

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure incorporate artificial intelligence (AI) and advanced machine learning techniques into threat actor infrastructure profiling (TAIP) to uncover previously hidden threat actor infrastructures. This includes the creation of a real-time (as described below), comprehensive threat intelligence (TI) graph, and leveraging guilt-by-association techniques to propagate TI labels to neighboring entities at machine scale. In some examples, each graph contains millions of interlinked entities and alerts, so that known TI coverage is expanded e.g., 2× on a per day basis. With AI-TAIP, telemetry from various sources (e.g., detectors, event logs, existing TI, anomalies, etc.) is integrated to create a comprehensive TI platform. Additionally, each risk score and threat actor attribution has a natural explanation mechanism by analyzing how neighboring components contribute to the overall score.

Using graph-based techniques, aspects of the disclosure represent complex relationships and connections between different entities, such as IP addresses, domains, and servers, and how these are interconnected with alerts and incidents across an organization. When combined with reputation propagation algorithms, the graph-based models as described herein enable cybersecurity teams to not only visualize threat actor infrastructure but also evaluate the trustworthiness of individual components within the network. This approach allows for more effective profiling by highlighting high-risk elements and potential targets for further investigation or mitigation. Examples of the disclosure leverage a graph-based approach to represent the infrastructure/entities used by threat actors along with their relationships with alerts, incidents, and organizations in a TI graph. Using reputation propagation techniques, the system assigns risk scores to various entities within the graph, helping to identify potentially malicious components and enabling cybersecurity professionals to prioritize their response efforts. This system provides a scalable and efficient way to profile threat actor infrastructure, enhancing overall threat detection and mitigation capabilities.

Aspects of the disclosure provide systems and methods for generating AI infused threat infrastructure profiling. A TI graph is created based on relationships in telemetry data obtained from a database. The TI graph comprises a plurality of known entities (e.g., known to be good/bad) and a plurality of unknown entities (e.g., good/bad status is not known). Risk scores for the plurality of known entities in the TI graph are initialized from a TI database. One or more of the plurality of unknown entities are classified, using a reputation propagation algorithm, based on relationships of the plurality of unknown entities with the plurality of known entities and the risk scores for the plurality of known entities in the TI graph. For example, an unknown entity is classified as benign or malicious, with a probabilistic interpretation ranging from 0 to 1. Here 0 is benign and 1 is malicious, with 0.5 meaning unknown and confidence ranging in between. In some examples, threat actor attribution of the unknown entity classifies it into one of multiple threat actor classes (e.g., entity associated with infrastructure from a country with known risks).

The reputation propagation algorithm (e.g., a label propagation algorithm) propagates threat actor labels to one or more of the plurality of unknown entities that are neighboring to the plurality of known entities at machine scale (e.g., at a level of granularity of an individual node). A remediation action is recommended for the classified one or more of the plurality of unknown entities e.g., if the entity is classified as malicious. The remediation action for the classified one or more of the plurality of unknown entities is automatically initiated. For example, the remediation action is automatically initiated based on user preference (e.g., if the user has configured to automatically initiate action based on the recommendation) or based on a severity of the recommendation (e.g., when the risk score is above a threshold).

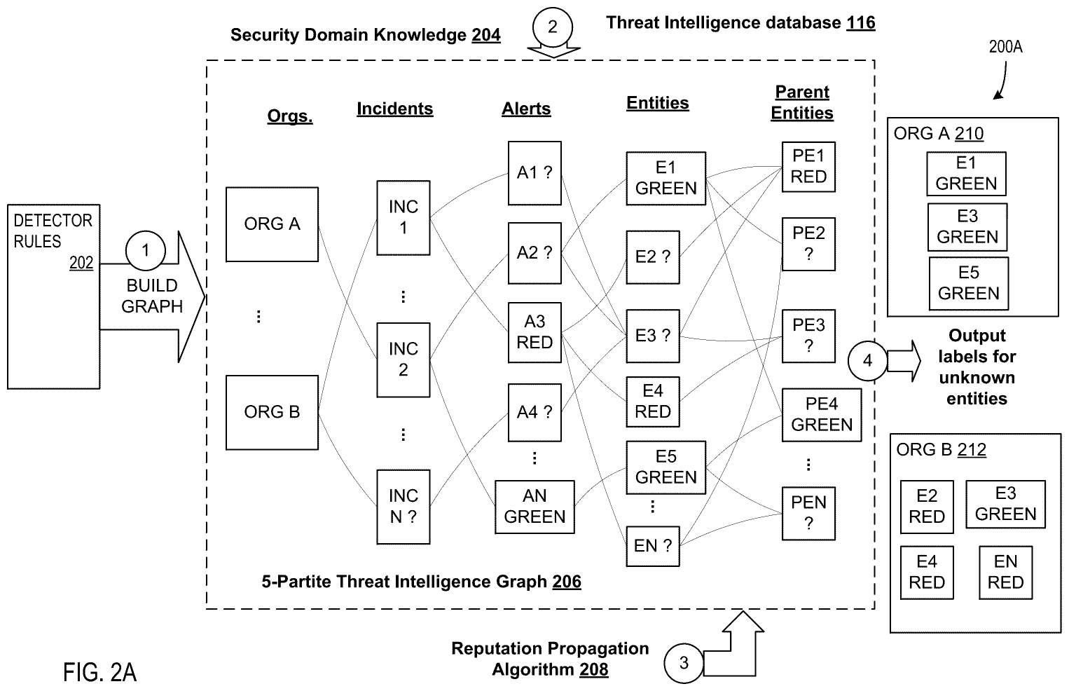

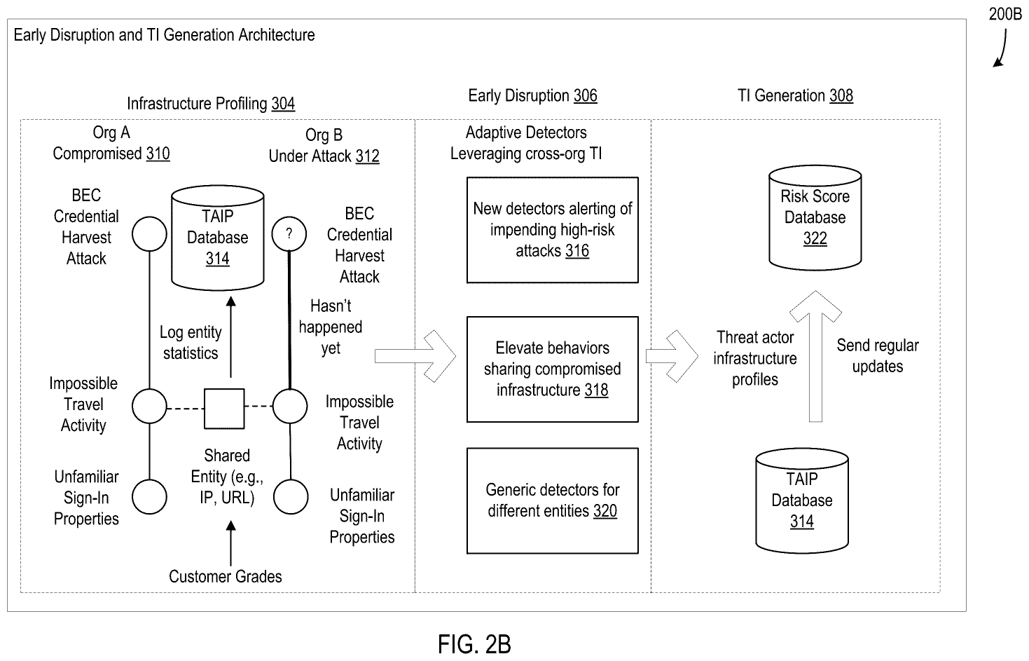

In some examples, the TI graph is a k-partite TI graph, wherein value of k is more than one. The k-partite TI graph includes entities (e.g., known and unknown entities that are visually distinguished in a user interface based on their classification labels types such as benign/malicious), alerts, incidents, and organizations. An exemplary 5-partite TI graph (e.g., as shown in FIG. 2A) includes the organization, incidents, alerts, entities, and parent entities. In some examples, edges in the TI graph have weights such that weight of at least one of the edges in the TI graph is adjusted over time using an edge decaying weight function that indicates a rate of decay in the weight of the at least one of the edges in the TI graph. The edge decaying weight function is modelled by a different function of time for each of the edges based on edge relationships between different entities. For example, IP address may be initially assigned a weight of 0.8 and this weight is reduced to 0.6 after 8 hours. As another example, weight for a file does not change with time.

Examples of the disclosure leverage the TI graph and reputation propagation algorithms to predict the likelihood that an incident is a true positive. In some examples, the reputation propagation mechanism can be leveraged to create an organization level risk score that is calculated for an organization based on an output of the TI graph. For example, if multiple entities of an organization are compromised in the TI graph, the aggregated risk score of these entities of the organization indicates how compromised the organization is (e.g., a score of 0.5 or more indicates that the organization is compromised while a score of less than 0.5 indicates that the organization is not compromised). This predictive capability can be integrated into AI assistants or AI response systems, enabling to expand coverage and provide customers with new targeted triage and remediation action recommendations that may be acted upon automatically.

A job (e.g., a PySpark job) that performs large-scale data processing in a distributed environment is developed on a geo-diversified processing platform. The job builds on the TI created from detectors (e.g., Extended Detection and Response (XDR) and Security Information and Event Management (SIEM) based detectors which collect and analyze data to detect cyber threats). Initially, TAIP (not AI-TAIP) is used to bootstrap the TI initialization process. Thereafter, this job generates AI-TAIP in a centralized intelligence repository, offering security researchers an expansive repository of telemetry to create adaptive detection rules and enable early attack disruption, while simultaneously generating new TI to support a security response center. The graph creation and reputation propagation algorithms are run in production as required (e.g., every hour), providing real-time TI to security researchers and customers.

Aspects of the disclosure operate in an unconventional manner at least by creating a TI graph, comprising known entities and unknown entities, based on relationships in telemetry data. Risk scores for the known entities in the TI graph are initialized and one or more of the unknown entities are classified based on relationships of the unknown entities with the known entities and the risk scores for the known entities in the TI graph. A remediation action for the classified unknown entities is recommended and automatically initiated for the classified unknown entities. By the described use of the TI graph and reputation propagation algorithm, examples of the disclosure accurately classify and recommend remediation even for the unknown entities, thus enhancing security to the computing resources (e.g., processing, memory, and/or network resources) such as by mitigating and preventing future cyber threats.

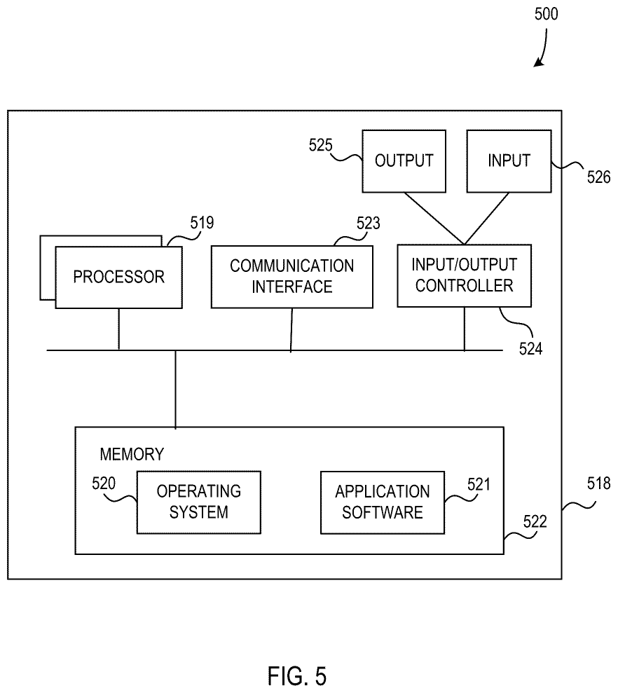

FIG. 1 is a block diagram illustrating an exemplary system 100 configured to generate AI infused threat actor infrastructure profiling. The system 100 includes a computing device 102 (e.g., the computing apparatus of FIG. 5) comprising a user interface 105, a processor 104, and a memory 106 storing program code 108 that upon execution by the processor 104 generates a TI graph 110 on the user interface 105 based on relationships in telemetry data obtained from a database 112. The TI graph 110 comprises known entities and unknown entities. The telemetry data may be obtained via a network 114 (e.g., an intranet, the Internet, a cellular network, other wireless network, other wired network, or the like). Alternatively, the database 112 is directly accessible to the computing device 102. Risk scores for the plurality of known entities in the TI graph 110 are initialized from a TI database 116 that may be accessible to the computing device 102 directly or via the network 114. One or more of the plurality of unknown entities are classified using a reputation propagation algorithm based on relationships of the plurality of unknown entities with the plurality of known entities and the risk scores for the plurality of known entities in the TI graph 110. A remediation action is recommended for the classified one or more of the plurality of unknown entities. Based on the recommendation, the remediation action is automatically initiated for the classified one or more of the plurality of unknown entities. In response to the remediation action, the TI graph 110 is updated on the user interface 105.

While the telemetry data 112 and the TI database 116 are shown distributed over the network 114, in some examples, the telemetry data 112 and TI database 116 are stored on the same storage infrastructure.

FIG. 2A is a diagram illustrating an architectural overview 200A of the AI-TAIP framework within a single geographic region. The process involves four key steps: (1) constructing a graph using telemetry from a platform for Extended Detection and Response (XDR) and Security Information and Event Management (SIEM) based detectors which collect and analyze data to detect cyber threats, (2) integrating known-good and known-bad threat intelligence (TI) from systems such as TAIP which is used to bootstrap the initial TI generation process, (3) applying reputation propagation algorithms to classify previously unknown entities as either good or bad, and (4) outputting the labels for the unknown entities within the graph.

Telemetry data related to cyberthreats is collected through various tools and techniques that monitor, analyze, and report on the activities and behaviors of systems, networks, and applications. This data helps cybersecurity teams to detect, understand, and mitigate potential cyberthreats more effectively using examples of the disclosure. Example methods and sources for collecting telemetry data related to cyberthreats are: (1) Endpoint Detection and Response (EDR) solutions deployed on endpoints (such as desktops, laptops, servers, and mobile devices) to detect suspicious behavior by collecting data on processes, files, network connections, registry changes, and etc., (2) SIEM systems that aggregate and analyze log data from multiple sources, including servers, firewalls, intrusion detection/prevention systems, and applications allowing security teams to correlate events across the infrastructure to detect potential threats and unusual behavior, (3) Mobile Device Management (MDM) and Mobile Threat Defense (MTD) solutions that monitor mobile devices for threats such as malicious applications, network attacks, and device compromises by collecting telemetry related to application usage, device configurations, and network connections, and etc. The use of different telemetry sources allows security teams to respond to cyberthreats more quickly and with greater accuracy.

Graphs provide a powerful representation of TI by capturing the relationships between entities, alerts, incidents, and organizations. For instance, entities such as IP addresses, files, and domains are interconnected with alerts and incidents, forming a complex web of interactions. A graph structure enables the analysis of these relationships, offering a clear and intuitive view of how different components influence each other. This interconnectedness is used for identifying patterns that may not be visible when examining isolated data points.

Using this graph structure, or other structures that capture relational information, allows performance of advanced analyses that would otherwise be challenging or impossible. A particularly powerful technique is reputation propagation, which spreads risk scores and threat actor labels across the graph. By initializing entity nodes with risk scores from 0 to 1 and labeling alert nodes with threat actor labels, algorithms of the disclosure propagate these scores and labels to previously unclassified entities. This dynamic assessment helps identify the risk of unknown entities based on their connections to known threats. By propagating threat actor labels, accuracy of identifying malicious entities that were previously unclassified is enhanced.

As illustrated in FIG. 2A, detector rules 202 are used by security detectors (e.g., thousands of security detectors) protecting customers (e.g., millions of customers) across multiple organizations to generate telemetry data. This telemetry data is used in operation 1 to build a TI graph (e.g., a 5-partite TI graph 206) based on the security domain knowledge 204 and further telemetry data obtained from threat intelligence database 116 in operation 2. The 5-partite TI graph 206 shows two organizations (e.g., Org A and Org B) that may encounter incidents (e.g., INC 1, INC, 2, and INC 3). These incidents trigger alerts (e.g., A1, A2, A3, A4, and AN), some of which are risky (e.g., A3 which is marked Red), some are safe or not risky (e.g., AN which is marked Green), and the status of some of the alerts is not known (e.g., A1, A2, and A4 which are marked with a question mark). These alerts are associated with entities (e.g., E1, E2, E3, E4, E5, and EN), some of which are marked risky (e.g., E4 which is marked Red), some are safe or not risky (e.g., E1 and E5 which are marked Green), and the status of some of the entities is not known (e.g., E2, E3, and EN which are marked with a question mark). In some examples, the entities have parent entities (e.g., PE1, PE2, PE3, PE4, and PEN)), some of which are marked risky (e.g., PE1 which is marked Red), some are safe or not risky (e.g., PE4 which is marked Green), and the status of some of the parent entities is not known (e.g., PE2, PE3, and PEN which are marked with a question mark).

In some examples, the reputation propagation algorithm 208 iteratively updates labels for the unknown entities and/or known entities with low confidence scores in operation 3 which rebuilds the TI graph 206. Once the status of all the unknown entities is known or after the status of a threshold number of entities for an organization of interest (e.g., Org A and/or Org B) is known, labels for the unknown entities are output in operation 4. For example, entities E1, E3, and E5 associated with Org A 210 are safe or not risky (e.g., marked Green) and entities E2, E4, and EN associated with Org B 212 are risky (e.g., marked Red) and entity E3 is safe or not risky (e.g., marked Green).

Some infrastructure entities that can be compromised or leveraged by threat actors, include:
(1) File—Malicious files are used to compromise devices,
(2) FileFolder—Malicious files are often stored in the same folder,
(3) DeviceName—Computer devices are a common attack vector,
(4) ResourceId—resources (e.g., Azure resources) are a common attack vector,
(5) ResourceName—resource names are recycled in attacker scripts across organizations,
(6) SessionId—Tracks the actions conducted by an attacker during a specific session,
(7) Registry ValueName—Attackers reuse registry values during attacks,
(8) RegistryKey—Attackers target particular registry keys during attacks,
(9) IpAddress—Malicious IP addresses are commonly reused across organizations,
(10) IpRange—Malicious IPs are commonly switched between different attack stages,
(11) URL—URLs are commonly sent by attackers to phish multiple organizations,
(12) UrlDomain—Attacker URLs can change, but the domains stay the same,
(13) InternetMessageId—Identical emails are often sent as part of phishing scams,
(14) EmailClusterId—Group of emails related to each other, often part of a campaign,
(15) OauthApplicationId—Shared application infrastructure is often used to facilitate attacks,
(16) SenderAccountUpn—Malicious email accounts are used to phish other organizations, etc.

Every hour (or as configured) the PySpark job calculates risk score and threat actor labels for each entity looking back over the last 48 hours (or as configured) of AlertEvidence telemetry. Table 1 shows an example schema for each table row.

TABLE 1
Example statistical profiling for AI-TAIP

| | | Risk | | Threat | | | | | |
|---|---|---|---|---|---|---|---|---|---|
| Entity | Entity | Score | | Actor | | LP RS | | LP TA | LP TA |
| Type | Value | (RS) | Explanation | (TA) | LP RS | Explain | LP TA | Conf. | Explain |
| Ip | I 1 | 0.5 | TAIP | | 0.9 | [Entity: . . . ] | Storm | 0.4 | [Entity: . . . ] |
| Ip | I 2 | 0.8 | RiskScoreData | | 1 | [Entity: . . . ] | | | |
| Ip | I 3 | 1 | TAIP | | 1 | [Entity: . . . ] | Blizzard | 0.9 | [Entity: . . . ] |
| Ip | I 4 | 0.7 | RiskScoreData | | 0.3 | | | | |
| Email | E1 | 0.3 | EmailEvents | | 0 | | Storm | 0.7 | [Entity: . . . ] |
| Ip | I 6 | 0.6 | TAIP | | 1 | [Entity: . . . ] | | | |
| Email | E2 | 0 | EmailEvents | | 0 | | | | |
| Url | U2 | 0 | AlertEvidence | Storm | 0 | | Storm | 1 | [Entity: . . . ] |
| Url | U2 | 0.5 | | | 0.7 | | | | |
| Url | U3 | 1 | RiskScoreData | | 1 | [Entity: . . . ] | | | |
| OAuth | O1 | 1 | AlertEvidence | Blizzard | 1 | [Entity: . . . ] | Blizzard | 1 | [Entity: . . . ] |
| Url | U4 | 1 | TAIP | | 1 | [Entity: . . . ] | | | |
| Ip | I 7 | 0.5 | | | 0.8 | | | | |
| Url | U5 | 0.5 | | Blizzard | 0.3 | | Blizzard | 1 | [Entity: . . . ] |
| OAuth | O2 | 0.5 | | | 0 | | | | |
| Ip | I 8 | 0.8 | TAIP | | 1 | [Entity: . . . ] | | | |
| Url | U6 | 0.8 | AlertEvidence | | 0.2 | [Entity: . . . ] | | | |
| Url | U7 | 0.9 | AlertEvidence | Storm | 0.95 | [Entity: . . . ] | Storm | 1 | [Entity: . . . ] |
| Ip | I 9 | 0 | AlertEvidence | | 0 | | | | |
| Url | U8 | 0.9 | RiskScoreData | | 1 | [Entity: . . . ] | | | |

Herein, ‘LP’ is label propagation, ‘RS’ is risk score, and ‘TA’ is threat actor. The column ‘Explanation’ defines the source based on which values in the column ‘Risk Score (RS)’ are initialized. For example, ‘TAIP’ represents that the ‘Risk Score (RS)’ is populated using existing TI sources and telemetry data, ‘RiskScoreData’ represents that the ‘Risk Score (RS)’ is populated using alerts from XDR and SIEM detectors, ‘EmailEvents’ represents that the ‘Risk Score (RS)’ is populated using TI for email based entities, and ‘AlertEvidence’ represents that the ‘Risk Score (RS)’ is populated using the likelihood that each node represents malicious activity or not. The TA label ‘Storm’ represents a group in development and is a temporary designation given to an unknown, emerging, or developing threat activity. Once a criterion (or a criteria) is met, a group in development is converted to a named actor or merged into existing names. The TA label ‘Blizzard’ represents a threat actor belonging to Russia. ‘LP RS Explain’ and ‘LP TA Explain’ provide explanation for populating ‘LP RS’ and ‘LP TA Configuration’ columns respectively.

In addition to the statistics highlighted in Table 1, in some examples each non-empty explanation column (“LP RS Explain”, “LP TA Explain”) contains a nested list of dictionaries that identifies the contributing impact of up to five of the key neighboring entities.

The below JSON output represents why an entity is likely malicious e.g., based on a neighboring entity having URL yxz.com has a risk score of 0.92 and another neighboring entity having IP address 12.322.23.22 has a risk score of 0.98.

TABLE 2
The LPExplain column expanded from Table 1 breaks
down the aggregate impact of up to the top five
neighboring entities contributing to the score.

```
[
  {
    EntityType: Url,
    EntityValue: yxz.com,
    LPRiskScore: 0.92
  },
  {
    EntityType: IpAddress,
    EntityValue: 12.322.23.22,
    LPRiskScore: 0.98
  }
]
```

As illustrated in FIG. 2A, an undirected, weighted k-partite graph with five distinct layers is constructed: (1) organizations, (2) incidents, (3) alerts, (4) entities, and (5) hierarchical entities. Organizations have incidents, and there may be a collection of alerts in a security incident. The alerts can have many entities associated with them. The entities form relationships with the alerts and these relationships are denoted by edges. Entities often have a parent entity (e.g., an IP address has an IP range, URL has a URL domain, etc.). In FIG. 2A, relationships between organizations-incidents, incidents-alerts, alerts-entities, and entities-hierarchical entities are represented by edges. Examples of the disclosure are capable of implementing a different number of organizations, incidents, alerts, entities, and parent entities and their relationships than the ones illustrated in FIG. 2A without departing from the aspects of the disclosure.

FIG. 2B illustrates early disruption and TI generation architecture 200B through cross-organization threat actor infrastructure profiling (TAIP). Infrastructure profiling 304 of organizations (e.g., Organization A 310 and Organization B 312) is generated. Here, organization A 310 is compromised and organization B 312 may be under attack. Organization A 310 has faced Business Email Compromise (BEC) credential harvest attack, impossible travel activity and unfamiliar sign-in properties and therefore is determined to be a compromised organization. Organization B 312 has faced impossible travel activity and unfamiliar sign-in properties but the BEC credential harvest attack has not happened yet (as determined based on the log entity statistics from the TAIP database 314. For example, as illustrated in FIG. 2B, the TAIP database 314 for the two organizations is accessed using a shared entity (e.g., IP address, URL, etc.) to generate cross-organization TI. Adaptive detectors (e.g., new detectors alerting of impending high-risk attacks 316, detecting elevate behaviors sharing compromised infrastructure 318, and generic detectors for different entities 320, etc.) leverage the cross-organization TI to identify early disruption 306 that is used for TI generation 308. For example, unknown entities are labeled as safe or risky based on threat actor infrastructure profiles from TAIP database 314. The status of entities is stored in a risk score database 322 which is regularly updated based on any updates in the TAIP database 314. While FIG. 2B illustrates two organizations, examples of the disclosure may advantageously implement cross-organization TI for more than two organizations without departing from the aspects of the disclosure.

By aggregating cross-organizational data, organizations can gain early warnings about entities observed in attacks against other organizations to provide proactive defense which enables an organization to adjust defenses before an attack occurs in their own environment. Risk scores reflect collective intelligence from multiple organizations, security products, and datasets to encourage a collaborative security posture, where insights from one organization benefit others. A well-defined risk score helps organizations prioritize investigations and responses, ensuring that high-risk entities receive immediate attention while avoiding overreaction to low-risk entities so that computing resources of the organization are optimally utilized.

Returning to FIG. 2A, each layer connects directly only to the adjacent layers, mirroring the relationships found in the security telemetry. For example, an IP address can connect to both an IP range and an alert, but not directly to an incident or organization. This structure not only reflects the natural hierarchy of the data but also ensures a graph structure is conducive to the reputation propagation algorithms reaching a stable distribution. In some examples, an organizational level risk score for an organization is calculated based on an output of the TI graph. The organizational level risk score indicates how compromised an organization is.

In some examples, a TI graph is constructed that combines all the telemetry across different organizations. For example, telemetry data of customers from different organizations across the world is leveraged to see how they all relate to each other. For example, if a security rule of a detector generates alerts for customers in an organization for an IP address, this same IP address is also seen to generate alerts for customers in another organization.

An exemplary geo-diversified distributed computation platform is leveraged to deploy AI-TAIP, creating a separate TI graph for each of the geographic regions (e.g., 16 regions). The job (e.g., PySpark job) runs periodically (e.g., hourly), generating graphs using the telemetry data of a time period (e.g., 1 day, 7 days, 14 days, etc.) from the AlertEvidence table (e.g., TI database 116) that contains alert telemetry generated from security detectors. These detectors and the alerts they generate come from multiple sources, including: (1) Microsoft security researchers, (2) customers, and (3) 3^{rd} party security companies. In some examples, the geo-diversified distributed computation platform advantageously performs preprocessing of at least a portion of the telemetry data (e.g., telemetry data other than the current day's data may be preprocessed) to generate the TI graph in real-time or near real-time. In a large region (e.g., Eastern US), the TI graph for a single run contains 6.7 million nodes and 30.1 million edges across 1,544 connected components. The node distribution is detailed in Table 3, while Table 4 provides a breakdown of the edge distribution between alerts, entities, and hierarchical entities.

TABLE 3
Example distribution of nodes in graph

| Entity | Node Count |
|---|---|
| OrgId | 13,193 |
| IncidentId | 312,061 |
| AlertId | 799,620 |
| InternetMessageId | 5,016,329 |
| SenderAccountUpn | 121,498 |
| Url | 112,966 |
| IpAddress | 94,799 |
| IpRange | 50,855 |
| SHA1 | 37,394 |
| DeviceName | 34,659 |
| SessionId | 29,105 |
| FolderPath | 23,741 |
| UrlDomain | 12,499 |
| EmailClusterId | 7,711 |
| ResourceId | 4,822 |
| AzureResourceName | 3,517 |
| RegistryKey | 2,285 |
| OAuthApplicationId | 911 |
| RegistryValueName | 764 |
| CampaignID | 223 |

TABLE 4
Example distribution of edges in graph

| Entity | Entity Pair | Edge Count |
|---|---|---|
| OrgId | IncidentId | 312,061 |
| IncidentId | AlertId | 797,488 |
| InternetMessageId | AlertId | 22,638,798 |
| SenderAccountUpn | InternetMessageId | 525,043 |
| EmailClusterId | InternetMessageId | 4,505,556 |
| Url | AlertId | 174,637 |
| UrlDomain | Url | 111,406 |
| IpAddress | AlertId | 738,952 |
| IpRange | IpAddress | 94,799 |
| SHA1 | AlertId | 75,203 |
| FolderPath | SHA1 | 43,619 |
| DeviceName | AlertId | 77,286 |
| ResourceId | AlertId | 11,150 |
| AzureResourceName | ResourceId | 3,650 |
| RegistryKey | AlertId | 5,298 |
| RegistryValueName | AlertId | 3,271 |
| OAuthApplicationId | AlertId | 1,266 |
| CampaignID | AlertId | 7,094 |
| SessionId | AlertId | 32,445 |

The nodes of the TI graph are initialized with risk scores from existing TI sources, telemetry data, alerts from XDR and SIEM detectors, and TI for email based entities (e.g., InternetMessageId, EmailClusterId), assessing the likelihood that each node represents malicious activity or not, and assigning an ActivityGroup label when available. The security domain knowledge is incorporated into the graph's edge weights, enabling to quantify the strength of relationships between entities over time.

For example, each entity node in the graph is initialized with a risk score ranging from 0 to 1, where 0 indicates a benign entity, 1 indicates a malicious entity, and 0.5 signifies an unknown status. Each AlertId node is assigned a RiskScore of 0.5 by default, unless the alert has been disrupted, in which case it is assigned a score of 1. A disruption alert indicates that an action has been taken automatically on behalf of the customer to remediate/contain the malicious activity on the customer's behalf. IncidentId nodes inherit the maximum RiskScore of the AlertId nodes they contain, while OrgId nodes are initialized with a score of 0.5. Entity node scores are determined using a combination of telemetry sources.

Table 5 displays the distribution of entity type initialization by source. Notably, 11.8% of the entities in the graph lack any telemetry, while the majority of labels (79%) are derived from the AlertEvidence table, which provides lower fidelity score initializations. The initializations for each entity type are carefully evaluated and selected by security research experts.

TABLE 5
Example distribution of entity RiskScore
initialization sources in graph

| Source | Entity Type | Count |
|---|---|---|
| TAIP | EmailClusterId | 371 |
| TAIP | InternetMessageId | 407 |
| TAIP | IpAddress | 13,670 |
| TAIP | IpRange | 14,270 |
| TAIP | OAuthApplicationId | 92 |
| TAIP | SenderAccountUpn | 5,873 |
| TAIP | Url | 615 |
| RiskScoreData | IpAddress | 11,780 |
| RiskScoreData | SHA1 | 627 |
| RiskScoreData | SenderAccountUpn | 13 |
| RiskScoreData | Url | 26 |
| RiskScoreData | UrlDomain | 313 |
| EmailEvents | EmailClusterId | 290 |
| EmailEvents | InternetMessageId | 443,644 |
| AlertEvidence | CampaignID | 223 |
| AlertEvidence | DeviceName | 22,328 |
| AlertEvidence | EmailClusterId | 6,701 |
| AlertEvidence | InternetMessageId | 4,057,037 |
| AlertEvidence | IpAddress | 47,240 |
| AlertEvidence | IpRange | 21,549 |
| AlertEvidence | OAuthApplicationId | 513 |
| AlertEvidence | RegistryKey | 2,285 |
| AlertEvidence | RegistryValueName | 764 |
| AlertEvidence | ResourceId | 2 |
| AlertEvidence | SHA1 | 25,382 |
| AlertEvidence | SenderAccountUpn | 98,082 |
| AlertEvidence | SessionId | 504 |
| AlertEvidence | Url | 111,469 |
| AlertEvidence | UrlDomain | 12,116 |
| None | AzureResourceName | 3517 |
| None | DeviceName | 12,331 |
| None | EmailClusterId | 349 |
| None | InternetMessageId | 515,241 |
| None | IpAddress | 22,109 |
| None | IpRange | 15,036 |
| None | OAuthApplicationId | 306 |
| None | ResourceId | 4,820 |
| None | SHA1 | 11,385 |
| None | SenderAccountUpn | 17,530 |
| None | SessionId | 28,601 |
| None | Url | 856 |
| None | UrlDomain | 70 |
| None | FolderPath | 23,741 |

In some examples, TAIP provides high-fidelity RiskScore initializations across seven entity types, covering around 0.6% of all entities in the graph. The base TAIP job assigns each entity a RiskScore from 0 to 1, where 0 indicates low risk and 1 indicates high risk. To better align these scores with AI-TAIP, where 0 represents benign and 1 represents high risk, the base TAIP scores are normalized to a range between 0.4 and 1. In some examples, an adaptive feedback system, that leverages customer grades on alerts to initialize alert nodes, is created. For example, an alert graded true positive (TP) by a customer could initialize a score to 0.8, and a false positive (FP) to 0.2, and a benign positive (BP) to 0.5. For example, an adaptive feedback including an alert grade is received from a customer and the risk scores for the unknown entities in the TI graph are initialized based on the adaptive feedback.

In some examples, TI (e.g., manually vetted TI by security research experts) delivers very high-fidelity RiskScore initializations across five entity types, accounting for 0.23% of all entities in the graph. Each column in the TI table (e.g., Table 6) contains a confidence score ranging from 0 to 100, which are normalized to a range of 0.5 to 1. To better align these scores with AI-TAIP, where 0 represents benign and 1 represents high risk, the risk scores are normalized to be 0.9 if the confidence≤0.8, otherwise the score is set to a confidence of 1.

EmailEvents telemetry provides additional RiskScore information for InternetMessageId and EmailClusterId entity types, contributing to 8% of the total score initializations. Scores are assigned based on the logic outlined in Table 6. Specifically, an EmailClusterId is initialized with a RiskScore of 1 if 40% or more of its associated InternetMessageIds have a RiskScore of 0.9 or higher.

TABLE 6
Example entity RiskScore initialization
strategy for EmailEvent telemetry

| ThreatName | ThreatTypes | Confidence | Score |
|---|---|---|---|
| IsNotEmpty & NotEicar | | | 1 |
| | Phish | High | 1 |
| | Phish | | 0.9 |
| | Malware | | 0.9 |
| | Spam | | 0.55 |

In Table 6, ‘Eicar’ refers to a test file and the risk score is high for “Phish” and “Malware” ThreatTypes compared to “Spam” TreatTypes.

AlertEvidence table uses telemetry from the XDR and SIEM detectors to initialize entities based on the metadata provided by the detector. This table is utilized to categorize entities into one of five types: Attacker, Compromised, Suspicious, Malicious, or NotAThreat. The initializations for Attacker, Compromised, and Malicious are directly mapped from the AdditionalFields column. For Suspicious, entities tagged as Policy Violator are also included, while NotAThreat encompasses Contextual tags, and any alerts associated with the “Email reported by user as not junk” detector. The detailed scoring breakdown for each entity type, informed by security research domain knowledge, is presented in Table 7. If a column is left blank, it indicates that the tag is not observed for that particular entity type.

TABLE 7
Example entity RiskScore initialization strategy for AlertEvidence telemetry

| Entity | Attacker | Compromised | Suspicious | Malicious | NotAThreat |
|---|---|---|---|---|---|
| AzureResourceName | | 0.7 | | 0.6 | 0 |
| ResourceId | | 0.7 | | 0.6 | 0 |
| IpAddress | 0.65 | 0.75 | 0.65 | 0.85 | 0 |
| IpRange | 0.65 | 0.7 | 0.6 | 0.7 | 0 |
| InternetMessageId | | | 0.6 | 0.75 | 0 |
| EmailClusterId | 0.8 | 0.8 | 0.6 | 0.8 | 0 |
| DeviceName | | | | 0.6 | 0 |
| OAuthApplicationId | 0.55 | 0.7 | 0.6 | 0.7 | 0 |
| RegistryKey | | | 0.7 | 0.9 | 0 |
| RegistryValueName | | | 0.7 | 0.9 | 0 |
| Url | | | 0.75 | 0.9 | 0 |
| UrlDomain | | | 0.75 | 0.9 | 0 |
| FolderPath | | | | | |
| SHA1 | | | 0.7 | 1 | 0 |
| SessionId | 0.7 | 0.7 | | | 0 |
| SenderAccountUpn | | | 0.6 | 0.9 | 0 |
| CampaignID | | | 0.6 | 0.8 | 0 |

AlertId nodes are initialized with threat actor labels derived from the telemetry from various sources, which includes threat actor names in the alert titles. These labels are far less common than risk scores, with fewer than 300 labels present across the entire graph (e.g., for a single snapshot of 48 hours for the Eastern US region).

In some examples, security domain knowledge is infused or otherwise added via edge weights. In the weighted k-partite TI graph, edge weights represent the strength of relationships between nodes. By default, the edge weight is set to 1. However, in some cases the edge weights are reduced e.g., (1) For edges connecting OrgId and IncidentId, the weight is lowered to 0.05 to allow for limited propagation between incidents within an organization, which could reveal missed correlations; and (2) For edges connecting IpAddress with AlertId and IpRange nodes, the weight is set to 0.75, acknowledging that IP addresses are highly transient entities that can quickly shift from malicious to benign and vice versa. The initially set weights of the edges change with time.

The graph creation period is extended by incorporating a historical AlertEvidence lookback of up to a week (or some other duration e.g., a month). To account for the varying permanence of entities over time, custom functions that represent the strength of entity relationships over time are introduced. For instance, a SHA1 entity could have a constant function ƒ(x)=1, while an IpAddress entity might have an exponential decay function ƒ(x)=e^{-cx}.

Reputation propagation uses the concept of “guilt by association” which is a powerful technique used in graph mining. Reputation propagation leverages the inherent structure of the TI graph to infer properties about unknown entities based on their relationships with known entities. By propagating threat actor labels and risk scores across the graph, understanding of the broader threat landscape and accuracy of identifying malicious entities that were previously unclassified is enhanced.

Some exemplary reputation propagation algorithms are: (1) label propagation, (2) label spreading, and (3) loopy belief propagation, (4) graph neural networks, etc. Each of these algorithms operates on the principle of spreading information across the graph, but each with its own unique advantages and applications. In some examples, graph neural networks may be modeled and/or executed. For example, a PySpark pipeline is created to process the data in a distributed manner, and then convert it to a format that is can be processed by GPUS using graph neural networks.

Label propagation (LP) typically offers the best convergence in terms of speed and predictability, particularly in well-structured and less complex graphs. It is the best choice when deterministic results and fast convergence are critical.

Label spreading (LS) converges better in noisy environments or when initial labels are unreliable. Its flexibility allows it to adapt to a wider range of scenarios, though at the cost of potentially slower convergence and the need for parameter tuning.

Loopy belief propagation (LBP) excels in detailed inference and handling complex structures, but it is more prone to convergence challenges like oscillations and requires more computational resources. It is best used when the graph's structure is complex, and capturing nuanced relationships is important, despite the potential for slower or less predictable convergence.

In some examples, the LP algorithm is selected due to its scalable performance on large graphs compared to LBP algorithm and no need to tune parameters compared to LS algorithm.

When implementing any of the algorithms, the TI graph G=(V, E) is converted into a sparse weighted adjacency matrix A with an initial label vector y containing either risk scores or threat actor labels for each node in the graph. If the risk score is unknown for the node, that node's risk score is set as 0.5. If the threat actor is not known, it to ‘Unknown’. We follow standard notation and use capital bold letters for matrices (e.g., A), lower-case bold letters for vectors (e.g., a) and calligraphic font for sets (e.g., S).

Graph structure plays a role in determining both the convergence behavior and scalability of graph-based algorithms like LP, LS, and LBP. Convergence depends on the graph structure, nature of information flow, and noisy graph labels. Graphs with clear community structures tend to facilitate faster and more stable convergence for algorithms like LP and LS as they can more easily propagate labels within clearly defined boundaries. In dense or cyclic graphs, convergence can be slower and less predictable, especially for LBP. The presence of many cycles or densely connected nodes can lead to conflicting updates and potential oscillations, making it harder for the algorithms to settle on a final label distribution.

The asymmetric information flow in directed graphs can sometimes lead to slower or less predictable convergence. For example, in LP, a node with many outgoing edges but few incoming edges may dominate the propagation process, leading to skewed results. Directed cycles (feedback loops) can also complicate convergence, potentially causing oscillations or requiring more iterations to stabilize.

Graphs with noisy initial labels can pose challenges for convergence, particularly if the graph structure does not strongly correlate with the labels. LS with its smoothing parameter is better suited to handle such conditions by balancing the influence of initial and propagated labels.

Scalability of the propagation algorithms depends on sparsity of the graph. Algorithms generally scale well with sparse graphs where the number of edges is much smaller than the square of the number of nodes. Sparse structures allow algorithms to operate efficiently, with time complexity typically proportional to the number of edges. A k-partite graph structure reduces the duplicate dependencies between nodes across differing layers in the graph as well as the overall computational complexity of the propagation algorithms that scale with the number of graph edges. For example, if there are 1 million nodes then to have a matrix to represent all possible connections will require 1 million by 1 million amount of memory. Using sparse matrices only store the connections between edges that exist and the for the nodes which makes the computation scalable and feasible at such large scales.

In examples of the disclosure, the TI graph is designed based on the convergence and scalability considerations. An undirected k-partite graph structure that offers multiple advantages in terms of convergence and scalability is leveraged in the examples of the disclosure. For example, in undirected graphs, the edges represent symmetric relationships between nodes, meaning information (such as labels or messages) can flow freely in both directions. The lack of directionality means that the propagation of information is more straightforward, often leading to faster and more predictable convergence. Algorithms like LP and LS are typically designed with undirected graphs in mind, where the balanced propagation of labels supports stable convergence.

The structured nature of a k-partite graph, where nodes are divided into distinct, non-overlapping sets, simplifies the propagation of labels. This reduces the likelihood of conflicting updates and minimizes the potential for cyclic dependencies, which can lead to faster and more stable convergence.

Label propagation is a semi-supervised learning technique that assigns labels to nodes based on the labels of their neighbors, iteratively refining the label distribution across the graph until convergence. This approach is particularly effective for very large graphs due to its computationally efficient approach. The label propagation algorithm operates by iteratively updating the labels of nodes in a graph based on the labels of their neighboring nodes.

The label propagation algorithm begins with an initial label matrix Y⁽⁰⁾, where each row corresponds to a node, and the two columns represent the probabilities of the node being benign (0) or malicious (1). A degree matrix D is computed, which contains the sum of the weights of edges connected to each node. The adjacency matrix A is normalized using Â=D⁻¹ A, which helps to evenly distribute influence across nodes. A mask M is created to identify nodes with high-confidence labels (i.e., those with initial probabilities ≥0.9 or ≤0.1), ensuring these labels remain unchanged during the iterations.

In each iteration of the label propagation algorithm, the label matrix Y^{(t)} is updated by multiplying the normalized adjacency matrix Â with the previous iteration's label matrix Y^{(t-1)}. This update effectively averages the labels of a node's neighbors, spreading the label information across the graph. After updating the labels, a mask M is applied to ensure that the high-confidence labels remain fixed. This is done by replacing the corresponding entries in Y^{(t)} with the original values from Y⁽⁰⁾ where the mask indicates that the label should not change. Use of mask advantageously reduces the amount of processing resource requirements because the risk score do not need to be recomputed for the values that are masked (due to high confidence).

To maintain a valid probability distribution, each row of the label matrix Y^{(t)} is normalized so that the sum of its elements equals 1. The algorithm checks for convergence by computing the Frobenius norm Δ=∥Y^{(t)}−Y^{(t-1)}∥_{F}. If the change between iterations is below a specified tolerance E, the algorithm terminates. This propagation process is repeated for up to 100 iterations or until convergence.

Similar to the label propagation algorithm, label spreading (LS) spreads labels throughout the graph but introduces a regularization mechanism to control the influence of initial labels. Label spreading is an extension of label propagation, incorporating a smoothing factor α to control the influence of the original labels throughout the propagation process. Similar to Label Propagation, the LS algorithm starts with an initial label matrix Y⁽⁰⁾ and computes the degree matrix D and the normalized adjacency matrix

$$\hat{A} = {D}^{- \frac{1}{2}} {AD}^{- \frac{1}{2}} .$$

The mask M is again used to protect high-confidence labels from changing during iterations.

The label matrix Y^{(t)} is updated using a combination of the previous iteration's propagated labels and the initial labels:

$${Y}^{( t )} = α \hat{A} {Y}^{( t - 1 )} + ( 1 - α ) {Y}^{( 0 )}$$

Here, α controls the influence of the propagated labels relative to the original labels. A higher α gives more weight to the labels spread through the graph, while a lower α retains more of the initial label information.

The mask M is applied to ensure that nodes with high-confidence initial labels remain unchanged. Row normalization is then applied to maintain the integrity of the probability distributions across the label matrix.

As with label propagation, the LS algorithm checks for convergence by measuring the change between iterations using the Frobenius norm. This propagation process is repeated for up to 100 iterations or until convergence.

Loopy Belief Propagation LBP) is a more sophisticated, but slower algorithm that operates by passing messages between nodes in a graph to update beliefs about each node's label. The algorithm starts by initializing messages

$${M}_{ij}^{( 0 )}$$

between each pair of connected nodes (i, j) based on the initial label matrix Y⁽⁰⁾. The initial beliefs Y⁽⁰⁾ for each node are set according to the initial label matrix.

For each iteration, the LBP algorithm updates the messages

$${M}_{ij}^{( t )}$$

sent from node i to node j based on the product of the messages received from all other neighboring nodes k (excluding j):

$${M}_{ij}^{( t )} = {\prod }_{k ∈ N ( i ) \backslash j} {M}_{ij}^{( t - 1 )}$$

These messages are then normalized to ensure that they form valid probability distributions. After updating the messages, each node's belief

$${Y}_{i}^{( t )}$$

is updated by combining the initial belief

$${Y}_{i}^{( 0 )}$$

with the product of the incoming messages from its neighbors:

$${Y}_{i}^{( t )} = {Y}_{i}^{( 0 )} {\prod }_{j ∈ N ( i )} {M}_{ji}^{( t )}$$

The beliefs are then normalized to maintain valid probability distributions. The LBP algorithm checks for convergence by computing the total change in beliefs across all nodes using the Frobenius norm described in LP. If the change A is below a specified tolerance ∈, the algorithm terminates.

In some examples, temperature scaling is used to calibrate confidence scores. For example, raw scores generated by the reputation propagation algorithms are converted into probabilistically interpretable scores for security researchers using temperature scaling that can be applied to both the risk score propagation and threat actor label propagation.

Temperature scaling is a calibration technique that is used to adjust the confidence of a model's predicted probabilities. In the context of graph-based label propagation, temperature scaling can be applied to the scores generated by the propagation algorithms to ensure that the resulting probabilities more accurately reflect the true likelihoods of each class. Temperature scaling is particularly useful when the model's predictions are overconfident, meaning that the predicted probabilities are too extreme (close to 0 or 1) and do not correspond well to the actual outcomes.

Graph-based label propagation models work by spreading label information through a graph, leveraging the connections between nodes to predict labels for unlabeled nodes. The output of such models often takes the form of logits or scores that indicate the relative strength or confidence of assigning each possible label to a node. However, these logits might not be well-calibrated, particularly when the model is prone to overconfidence. Temperature scaling “softens” these logits by introducing a temperature parameter T that controls the sharpness of the predicted probabilities. When the temperature T is greater than 1, the logits are scaled down, leading to softer probabilities that are less extreme. When T is less than 1, the logits are scaled up, making the probabilities more confident. In this way, temperature scaling finds the optimal temperature that balances the confidence of the predictions with the accuracy of the probabilistic calibration.

Temperature scaling is applied to graph-based label propagation to derive logits from label propagation. The graph-based label propagation model is assumed to produce a set of logits (unnormalized scores) for each node x in the graph. Let zᵢ(x) denote the logit for class i corresponding to node x. These logits are typically used to determine the class probabilities via the softmax function:

$$P ( y = i \vert x ) = \frac{exp ( {z}_{i} ( x ) )}{{\sum }_{j} exp ( {z}_{j} ( x ) )}$$

To apply temperature scaling, a temperature parameter T is introduced and the logits are scaled according to:

$${z}_{i}^{′} ( x ) = \frac{{z}_{i} ( x )}{T}$$

The scaled logits z′ᵢ(x) are then used to compute the calibrated probabilities:

$${P}_{T} ( y = i \vert x ) = \frac{exp ( {z}_{i}^{′} ( x ) )}{{\sum }_{j} exp ( {z}_{j} ( x ) )} = \frac{exp ( \frac{{z}_{i} ( x )}{T} )}{{\sum }_{j} exp ( \frac{{z}_{j} ( x )}{T} )}$$

The optimal temperature T is learned by minimizing a calibration loss, typically the negative log-likelihood (NLL) on a validation set:

$$NLL ( T ) = - \frac{1}{N} {\sum }_{n = 1}^{N} {\sum }_{i = 1}^{C} {y}_{n , i} ( x ) log ( {P}_{T} ( y = i \vert {x}_{n} ) )$$

Where N is the number of samples in the validation set; C is the number of classes; Y_{n,i}(x) is the true label indicator (1 if a node belongs to class i, otherwise 0) for sample n and class i; and P_{T}(y=i|xₙ) is the temperature-scaled probability for class i and sample n.

Minimizing this loss function involves finding the temperature T that produces the most accurate and well-calibrated probabilities according to the true distribution of labels in the validation set. Once the optimal T is found, it is applied to the entire dataset to produce calibrated probabilities for each node in the graph. These probabilities are then used for making final predictions or for further downstream tasks, producing probabilities that more accurately reflect the true likelihoods of each class.

In some examples, a logit representing an unnormalized score for a node in the TI graph is generated. The logit is scaled by applying temperature scaling and a calibrated probability is computed using the scaled logit. An optimal temperature is determined by minimizing a calibration loss of the computed calibrated probability. Based on the optimal temperature, calibrated probabilities are produced for one or more nodes in the TI graph according to a true distribution of labels in a validation set. Advantageously, the calibrated probabilities more accurately reflect the true likelihoods of each class.

Examples of the disclosure are used to explain the risk scores and threat actor labels. To explain a node's final class prediction, the labels of its neighboring entities are analyzed at the conclusion of the propagation process. If a node is classified as “malicious,” this outcome is likely due to the fact that many of its neighbors were also labeled as “malicious” during the propagation process. The collective influence of these neighbors provides a clear rationale for the final prediction. For example, if an IP address node ends up with a “malicious” label, examining the neighboring alert nodes that influenced this decision can provide context. If these neighboring alerts were connected to disrupted alerts with high-risk scores, or known bad IpRanges, this would explain why the IP address was ultimately classified as malicious.

The example TI graph as illustrated in FIG. 2A is interactive and provides an explanation as to why a particular entity is attributed as a particular threat actor and/or risk score. For example, a selective k-hop search is performed in the TI graph for a selected entity (e.g., a file selected by a user) of interest, and alerts and/or entities around the selected entity that are highly suspicious are used to determine the reason why the selected entity is attributed as risky.

In some examples, hidden threats are uncovered. A comprehensive evaluation of the risk scores and threat actor labels generated by AI-TAIP across various entity types is performed over a time period (e.g., over the last 24 hours, last 7 days etc.). The primary objective of the evaluation is to assess the accuracy of the predictions, ensuring that low risk scores correctly correspond to benign entities and high-risk scores accurately identify malicious entities. Additionally, the effectiveness of AI-TAIP as a foundational source of Threat Intelligence (TI) is determined by evaluating its potential to enhance detection, drive disruption efforts, enable robust correlation, and support Guided Response initiatives.

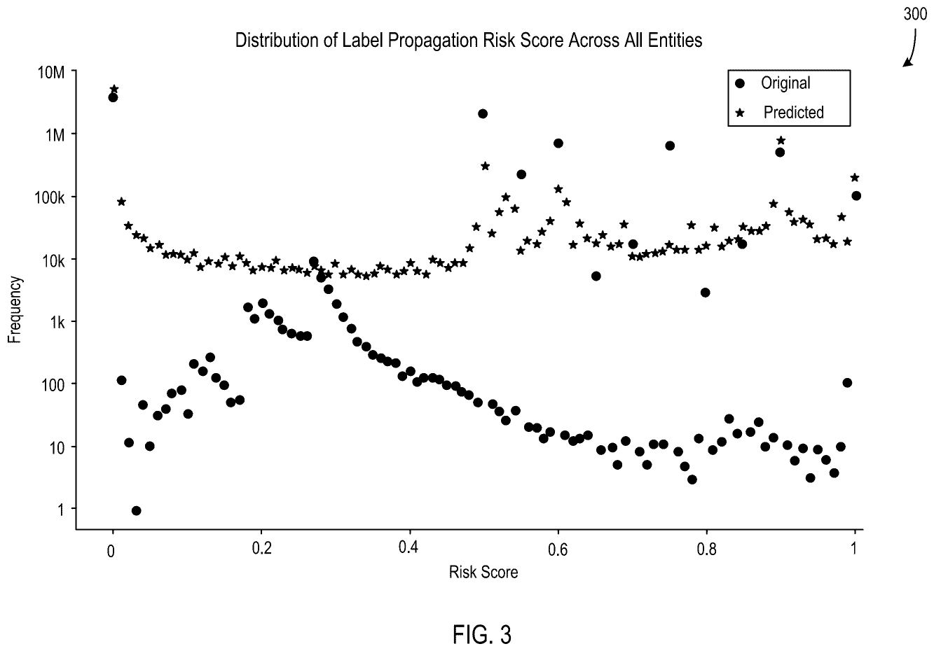

FIG. 3 illustrates distribution of risk scores across all entity types using label propagation. Entity risk score analysis begins by examining the distribution of risk scores across all entity types, and comparing the landscape before and after the application of AI-TAIP. In FIG. 3, the “original” scores, depicted in blue, represent the initial distribution of risk scores assigned to entities, prior to any reputation propagation. In contrast, the “predicted” scores, shown in red in FIG. 3, illustrate the distribution after applying the label propagation (LP) algorithm. As seen in FIG. 3, the LP algorithm significantly smooths the distribution, leading to a more refined and balanced assessment of risk across entities. After convergence, a substantial increase in the number of entities confidently classified as either “good” or “bad” is observed indicating a substantial increase in our TI capabilities. For example, a count of entities with original risk score of 0.5 (e.g., unknown entities before applying LP algorithm to the TI graph) that is around 5 million is advantageously reduced to a count of less than 1 million (predicted risk score of 0.5) after applying LP algorithm to the TI graph.

An analysis of Table 8 reveals the impact of AI-TAIP on generating confident risk scores for previously ambiguous entities. A confident risk score is defined as one that has experienced an absolute change of 0.3 or more. For instance, if an entity's initial RiskScore was 0.5 and it increased to 0.8, this is counted as a +1 in the metrics.

TABLE 8
Example impact of AI-TAIP on generating confident risk scores for previously ambiguous entities.

| | Region | | | | | | | | | |
|---|---|---|---|---|---|---|---|---|---|---|
| Entity Type | CUS | CUS3 | EUS2 | EUS3 | NEU | NEU3 | UKS | UKW | WEU | Total |
| AzureResourceName | 274 | 246 | 430 | 514 | 1025 | 175 | 52 | 39 | 901 | 3.7k |
| CampaignID | 110 | 88 | 140 | 69 | 123 | 41 | 28 | 16 | 139 | 754 |
| DeviceName | 14958 | 8158 | 21082 | 9070 | 19720 | 5230 | 2221 | 1579 | 24059 | 106k |
| EmailClusterId | 1078 | 797 | 1597 | 838 | 1339 | 242 | 211 | 82 | 1769 | 7.9k |
| FolderPath | 18336 | 11745 | 20970 | 8552 | 29024 | 7594 | 8111 | 1687 | 33437 | 139k |
| InternetMessageId | 599k | 260k | 1.13M | 374k | 821k | 17k | 44k | 96k | 993k | 4.4M |
| IpAddress | 19857 | 23171 | 27001 | 24105 | 53693 | 11605 | 3325 | 1979 | 37488 | 202k |
| IpRange | 16250 | 20021 | 20822 | 20105 | 42142 | 11366 | 2793 | 1124 | 30952 | 165k |
| OAuthApplicationId | 8 | 3 | 20 | 9 | 18 | 7 | 3 | 1 | 34 | 103 |
| RegistryKey | 45 | 80 | 54 | 45 | 115 | 30 | 126 | 6 | 87 | 588 |
| RegistryValueName | 23 | 44 | 36 | 49 | 64 | 19 | 3 | 7 | 57 | 302 |
| ResourceId | 375 | 366 | 599 | 800 | 1319 | 233 | 69 | 42 | 2356 | 6.2k |
| SenderAccountUpn | 11887 | 7208 | 15091 | 9118 | 9998 | 1886 | 1720 | 968 | 16562 | 74k |
| SessionId | 18591 | 18027 | 24973 | 21043 | 68202 | 6793 | 1216 | 358 | 85625 | 244k |
| SHA1 | 1863 | 1612 | 2368 | 1680 | 2650 | 253 | 328 | 76 | 3152 | 14k |
| Url | 755 | 393 | 1639 | 357 | 2876 | 248 | 128 | 74 | 1881 | 8.4k |
| UrlDomain | 114 | 45 | 96 | 51 | 125 | 33 | 17 | 13 | 165 | 659 |
| Total | 704k | 352k | 1.27M | 470k | 1.05M | 63k | 63k | 103k | 1.23M | 5.31M |

In an exemplary implementation, within just 24 hours across 9 of the 16 production regions, AI-TAIP added 5.3M high-confidence risk scores across entity types. This effect is particularly notable for entities such as InternetMessageId and IpAddress, where a substantial shift is observed towards more definitive risk classifications. This enhancement underscores AI-TAIP's ability to rapidly refine the Threat Intelligence (TI), enabling more accurate detection and response strategies. During the same 24-hour period, a risk score tool generated 2.7M active non-zero confidence TI entities. This means that AI-TAIIP is nearly doubling the currently available threat intelligence for downstream applications such as detection, disruption, and correlation.

An example implementation of AI-TAIP has undergone extensive evaluation to ensure the quality and effectiveness of the TI pipeline. A thorough analysis of hundreds of entities consistently demonstrates AI-TAIP's ability to generate novel TI across various infrastructure types, such as IPs, files, and emails. In the CUS3 region, the top 20% of newly uncovered entities with the highest risk scores led to the creation of 142 k new alerts across 11 k entities within 24 hours of being processed by AI-TAIP. In contrast, the lowest scoring 20% generated only 29 k new alerts across 5.7 k entities. This indicates that the high-confidence risky TI was subsequently seen across 5× more downstream alerts. Furthermore, the bottom 20% of entities accounted for 55% of all entities, while the top 20% comprised only 27%. After normalizing by entity volume, the high-confidence entities predicted to be malicious would result in 10× more downstream alerts, underscoring the precision and impact of AI-TAIP's risk scoring. The exact breakdown of the number of entities and alerts subsequently seen after being scored by AI-TAIP is broken down by entity type in Table 9.

TABLE 9
The top 20% of newly uncovered entities with the highest risk scores
led to the creation of 142k new alerts across 11k entities within
24 hours of being processed by AI-TAIP. In contrast, the lowest scoring
20% generated only 29k new alerts across 5.7k entities.

| | Confident Malicious | | Confident Benign | |
|---|---|---|---|---|
| | (≥0.8) | | (≤0.2) | |
| | # of | # of | # of | # of |
| Entity Type | Entities | Alerts | Entities | Alerts |
| IpAddress | 4,110 | 34,102 | 1994 | 8611 |
| IpRange | 5,466 | 87,386 | 1726 | 13549 |
| Url | 3 | 69 | 31 | 176 |
| UrlDomain | 0 | 0 | 37 | 858 |
| InternetMessageId | 53 | 68 | 458 | 556 |
| EmailClusterId | 0 | 0 | 24 | 64 |
| SenderAccountUpn | 50 | 229 | 925 | 3406 |
| SHA1 | 4 | 577 | 0 | 0 |
| DeviceName | 928 | 6,933 | 512 | 1492 |
| FolderPath | 598 | 11,899 | 0 | 0 |
| RegistryValueName | 0 | 0 | 0 | 0 |
| RegistryKey | 0 | 0 | 0 | 0 |
| AzureResourceName | 71 | 204 | 1 | 1 |
| ResourceId | 158 | 565 | 1 | 1 |
| CampaignID | 0 | 0 | 10 | 74 |
| OauthApplicationId | 0 | 0 | 1 | 1 |
| SessionId | 157 | 923 | 0 | 0 |
| Total | 11,598 | 142,955 | 5,720 | 28,789 |

In some examples, high confidence entities are monitored to identify some entities which do not result in downstream alerts. This means that there may be a gap in determining high confidence in such entities. Weights on edges connecting such entities is automatically lowered. In some examples, customer feedback is received identifying the gap in determining high confidence in such entities. Weights on edges connecting such entities is automatically lowered based on the customer feedback.

An analysis of Table 10 reveals the impact of AI-TAIP on generating confident threat actor labels for entities. A confident threat actor label is defined as >=0.8. Within just 24 hours across 9 of the 16 production regions, AI-TAIP tagged 2.9 k entities with confident threat actor labels. This tagging is particularly notable for entities such as SHA1, FolderPath, and IpAddress (in Table 9). This enhancement underscores AI-TAIP's ability to bolster the ability to attribute TI, enabling more accurate detection and response strategies.

TABLE 10
Example impact of AI-TAIP on generating confident threat actor labels for entities:

| | Region | | | | | | | | | |
|---|---|---|---|---|---|---|---|---|---|---|
| Activity Group | NEU | NEU3 | UKS | UKW | WEU | CUS | CUS3 | EUS2 | EUS3 | Total |
| Blizzard | 74 | | 64 | | 18 | 48 | 97 | 24 | 11 | 336 |
| Rain | 2 | | | | | | | | | 2 |
| Sandstorm | 122 | | 21 | | 34 | 48 | 83 | 47 | 2 | 357 |
| Sleet | 43 | | 2 | | 40 | 363 | 48 | 55 | 46 | 597 |
| Storm-* | 255 | 372 | 82 | 12 | 119 | 104 | 55 | 113 | 44 | 1,156 |
| Tempest | 33 | 1 | 5 | 46 | 15 | 38 | 16 | 80 | 31 | 265 |
| Tsunami | | | | | 1 | | | | | 1 |
| Typhoon | 84 | 3 | 23 | | 44 | 19 | 8 | 1 | 10 | 192 |
| Total | 613 | 376 | 197 | 58 | 271 | 620 | 307 | 320 | 144 | 2,906 |

In some examples, AI-TAIP advanced threat intelligence is used to enhance the detection and disruption rules built out and developed for TAIP, while simultaneously enabling brand new opportunities for each of the entity types. The AI-TAIP telemetry is used to develop advanced detection rules for IpAddress, Url, OauthApplicationId, SenderAccountUpn, and InternetMessageId. Examples of the disclosure may be used to develop new rules based on these entity types and other entity types.

Some embodiments contemplate a two-stage detection and disruption pipeline. In the first stage, detection rules are developed in the geo-diversified processing platform based on TAIP. In the second stage, the XDR and SIEM detectors are used as trigger indicators of attack (IOAs) for a research platform (e.g., Kusto Correlation Engine used by security researchers to write and develop new detectors) so that the base detections in stage one can be enriched with additional table telemetry to create high fidelity disruption rules.

Examples of the disclosure provide new Guided Response remediation action recommendations based on TAIP and AI-TAIP telemetry. Some exemplary recommendations are (1) recommend to block alert IpAddresses, (2) recommend to block alert URLs, and (3) recommend to delete alert emails. Some other exemplary recommendations are for applications (e.g., using OAuthApplicationId), files, devices, etc.

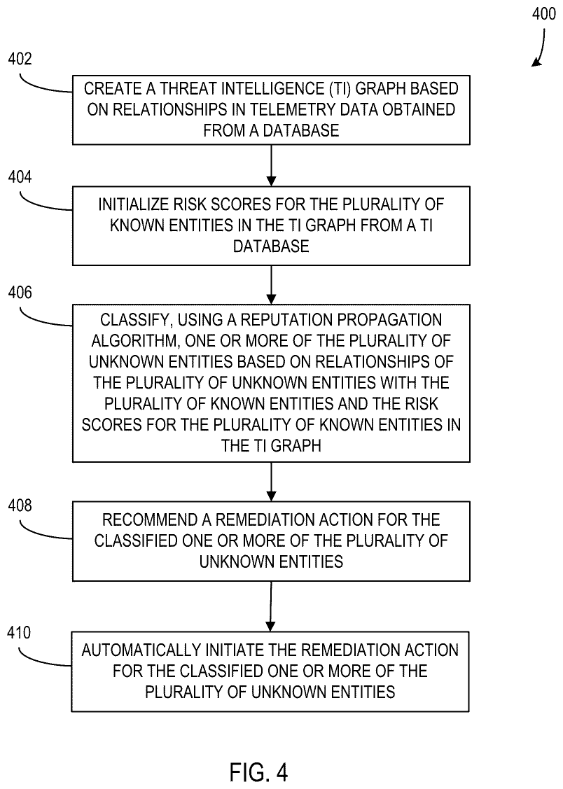

FIG. 4 is a flowchart illustrating an exemplary method 400 for generating AI infused threat infrastructure profiling. In some examples, the method 400 is executed or otherwise performed in a system such as system 100 of FIG. 1.

At 402, a TI graph is created based on relationships in telemetry data obtained from a database. The TI graph comprises a plurality of known entities (e.g., known to be good/bad) and a plurality of unknown entities (e.g., good/bad status is not known). At 404, risk scores for the plurality of known entities in the TI graph are initialized based on values from a TI database. At 406, one or more of the plurality of unknown entities are classified, using a reputation propagation algorithm, based on relationships of the plurality of unknown entities with the plurality of known entities and the risk scores for the plurality of known entities in the TI graph. At 408, a remediation action is recommended for the classified one or more of the plurality of unknown entities. At 410, the remediation action for the classified one or more of the plurality of unknown entities is automatically initiated e.g., based on user preference, historical acceptance of the recommendations by the user, a level of confidence in the recommendation, or the like. Based on the remediation action, a change in relationship between the known entities and the unknown entities is identified and the TI graph is updated in response to the remediation action (e.g., in accordance with the identified change in relationships between the known entities and the unknown entities).

In some examples, an effectiveness of the remediation action is determined by observing if alerts are still coming in for the classified one or more of the plurality of unknown entities (which are now no longer unknown) for which the remediation action was initiated. If after the remediation action, alerts are not coming then the remediation action is effective and a similar remediation action is initiated in future for some other entities. If after the remediation action, alerts are still coming, one or more of: parameters of the reputation propagation algorithm, the reputation propagation algorithm, weights of nodes of the TI graph, and weights of edges of the TI graph are updated.

In some examples, a triaging recommendation for the classified unknown entities is provided. The triaging recommendation indicates whether the classification is true positive or false positive. The remediation action for the classified unknown entities is prioritized based on the triaging recommendation. In some examples, labels are provided to incidents and alerts. For example, if an incident or an alert is a true positive or a false positive. Based on this labeling, incidents are prioritized for investigation. For example, a true positive incident will be prioritized over another incident that is a false positive. In some examples, a recommendation for triaging is provided based on the labeling. The triaging recommendation is provided to the customers through the threat intelligence graph that is created. Examples of the disclosure advantageously label if the whole incident is bad (or the risk profile for the whole organization) whereas most threat intelligence systems only focus on individual components of the whole threat intelligence graph.

In some examples, one or more of the risk scores associated with the known entities are propagated to one or more of the unknown entities using the reputation propagation algorithm and the propagated risk scores are converted (using temperature scaling) into probabilistically interpretable scores for security researchers. Alternatively, or in addition, threat actor labels associated with the known entities are propagated to one or more of the unknown entities and the propagated threat actor labels are converted (using temperature scaling) into probabilistically interpretable scores for security researchers. The probabilistically interpretable scores (e.g., converted from one or both the propagated risk scores and the propagated threat actor labels) are provided along with the TI graph for the security researchers.

In some examples, an entity, having a high confidence level of the classification (e.g., a confidence level above a threshold such as 95%) and that is not creating new downstream alerts, is identified from the classified one or more of the plurality of unknown entities. Based on the identification, parameters of the reputation propagation algorithm, weights of nodes of the TI graph, and/or weights of edges of the TI graph are automatically updated. The TI graph is also updated over time as some of the edges and entities may go stale.

In some examples, a separate TI graph is created for a plurality of geographic regions and a different reputation propagation algorithm is used for the plurality of TI graphs for the plurality of geographic regions. In this way, an optimized reputation propagation algorithm is used for each region based on different configurations of entities and other parameters. Creating separate TI graphs for each geographic region further helps in meeting General Data Protection Regulation (GDPR) that may vary for the different geographic regions.

In some examples, threat actor attribution information is also profiled. For example, if the attack is coming from a particular location or country. Using ground truth information on where the attacks are coming from, other attacks might also be determined to originate from the same threat actor infrastructure pieces. In some examples, the initial risk score node labels for entities are bootstrapped without known ground truth values e.g., using TAIP (before the job generates AI-TAIP).

In some examples, risk score node labels (TAIP based or AI-TAIP based) for entities in a first organization are used to bootstrap the initial risk score node labels for entities in a second organization different from the first organization. This advantageously allows cross-organizational profiling of TI. The AI-TAIP risk scores are initialized with cross-organizational profiling of threat actor infrastructure (TAIP). By monitoring the infrastructure—such as IP addresses, domains, and servers—used in attacks against one organization (e.g., Organization A), insights can be shared and applied to protect other organizations (e.g., Organization B). This approach allows the TI system to detect and mitigate threats before they materialize, as threat actors often reuse infrastructure across multiple campaigns.

For example, if Organization A experiences an attack from a specific set of command-and-control servers, the TI system can flag these servers as high-risk. By sharing this intelligence across organizations, the system can proactively alert Organization B to block or monitor traffic to those servers, potentially preventing a similar attack (see FIG. 2B). This collaborative intelligence fosters a broader, more unified defense, allowing organizations to benefit from each other's experience and increasing the overall resilience of the security ecosystem.

By expanding the cross-organizational threat infrastructure monitoring approach, intelligence from multiple organizations is aggregated to generate a comprehensive risk score for each entity (e.g., IP addresses, domains, threat actor infrastructure). This risk score would be based on key metrics derived from various intuitions, enabling organizations to prioritize threats and allocate resources more effectively. Some of the key factors that could contribute to the creation of a robust risk score are (1) Number of Organizations Identifying the Entity as True Positive (TP), (2) Number of Alerts Associated with the Entity, (3) Number of Unique Indicators of Attack (IOAs) Linked to the Entity, (4) Number of True Positive (TP) Graded Alerts, (5) Number of False Positive (FP) or Benign Positive (BP) Graded Alerts, (6) Number of Organizations Observing the Entity, (7) Number of Security Products Flagging the Entity, etc.

Number of Organizations Identifying the Entity as True Positive (TP)—The risk score is influenced by the number of organizations that have flagged an entity as a True Positive (TP) based on their alert or incident grading systems. The more organizations that identify an entity as a confirmed threat, the higher its risk score. This consensus provides strong evidence of malicious activity and threat actor involvement, creating an aggregate view of the entity's threat potential across multiple environments.

Number of Alerts Associated with the Entity—The frequency with which an entity appears in alerts across organizations is a key indicator of its activity level. A higher number of associated alerts suggests more widespread use of the entity in malicious operations, increasing its risk score. Each alert contributes to the entity's profile, offering valuable data points for determining whether its behavior is suspicious or benign.

Number of Unique Indicators of Attack (IOAs) Linked to the Entity—The diversity of Indicators of Attack (IOAs) associated with the entity reflects the variety of tactics, techniques, and procedures (TTPs) used by the threat actor. An entity linked to numerous, unique IOAs indicates that it is part of a sophisticated or versatile infrastructure. As the number of unique IOAs increases, so does the entity's risk score, indicating the breadth of its threat potential.

Number of True Positive (TP) Graded Alerts—The proportion of TP graded alerts directly associated with the entity strengthens the certainty that it is part of a malicious operation. If an entity consistently appears in TP alerts, this highlights its threat relevance across multiple environments. Entities with higher counts of TP alerts receive a proportionally higher risk score due to the verified nature of their malicious activity.

Number of False Positive (FP) or Benign Positive (BP) Graded Alerts—the number of False Positive (FP) or Benign Positive (BP) alerts reduces the risk score for an entity. If organizations frequently identify an entity in FP or BP graded alerts, it indicates that the entity may be incorrectly flagged as suspicious or has benign uses in legitimate contexts. A lower count of FP/BP alerts leads to a higher risk score, as this suggests the entity is more likely to be a true threat.

Number of Organizations Observing the Entity—The more organizations that observe and report on the entity, the higher its potential risk. Entities observed across a wide range of environments are more likely to be part of large-scale, cross-organizational campaigns or infrastructure re-use by threat actors. The presence of the entity in multiple organizations strengthens the case for its inclusion in a high-priority threat watchlist.

Number of Security Products Flagging the Entity-If an entity is flagged by multiple security products (e.g., firewalls, antivirus, endpoint detection and response tools), this further validates its risk. A higher number of detections across different tools and platforms signifies the entity's pervasive use in attacks, thus contributing to a higher risk score. The diversity of security product detections can indicate the entity's role in multi-vector attacks, further solidifying its threat status.

The TI system (such as system 200B) can combine these metrics in a scoring algorithm to produce a composite risk score for each entity. The aggregation process would consider factors such as weighting, normalization, and historical analysis. Certain metrics, such as the number of TP graded alerts or the number of organizations observing the entity, may carry more weight in the calculation. This ensures that the risk score reflects the severity and consistency of an entity's malicious activity. Metrics can be normalized across organizations and environments to ensure that the scoring system is fair and scalable, regardless of an organization's size or the volume of alerts they process. The TI system can track how an entity's risk score evolves over time. This temporal analysis helps identify emerging threats or infrastructure that was previously low-risk but has become more active or dangerous.

To evaluate the performance of AI-TAIP (AI-based Threat Actor Infrastructure Profiling) on label propagation results, an 80-20 split of labeled risk score data is used to ensure robust and balanced testing. For each entity type (e.g., IP addresses, domains, or devices), the dataset is partitioned by holding out 20% of the benign entities and 20% of the malicious entities as a test set, while the remaining 80% forms the training set. The ground truth comes from manually vetted TI entities, and high confidence detectors, and TAIP entities. This approach allows assessing AI-TAIP's ability to propagate labels accurately across the graph by testing how well the model can predict the correct labels for the unseen 20% of both benign and malicious entities. By ensuring that the test set contains an even representation of both benign and malicious entities, the model's precision and recall is evaluated on different types of entities, ensuring that it doesn't overfit to one class or the other.

The 80-20 split also provides insight into the model's generalization capability, that allows measuring how effectively AI-TAIP identifies malicious infrastructure based on partial information. The balanced 80-20 split ensures a fair and meaningful performance evaluation to understand how well the label propagation algorithm works in identifying both benign and malicious entities in real-world scenarios. The results from this experiment are represented in Table 11 below. Table 11 shows that AI-TAIP consistently predicts TI entity risk level with an overall F1-score of around 0.99 across all entity types in a medium sized geographic region.

TABLE 11
TAIP Results

| Entity | F1 Score | Precision | Recall | AUC | Support |
|---|---|---|---|---|---|
| SenderAccountUpn | 0.9855 | 0.9728 | 0.9986 | 0.9691 | 2531 |
| EmailClusterId | 0.9582 | 0.9767 | 0.9403 | 0.9902 | 175 |
| InternetMessageId | 0.9983 | 0.9971 | 0.9995 | 0.9963 | 45928 |
| Url | 0.9557 | 0.9223 | 0.9916 | 0.9309 | 3805 |
| SHA1 | 1 | 1 | 1 | 1 | 688 |
| UrlDomain | 0.9858 | 0.9811 | 0.9905 | 0.9971 | 218 |
| IpAddress | 0.957 | 0.9845 | 0.931 | 0.9803 | 1734 |
| Overall | 0.9873 | 0.9787 | 0.996 | 0.9894 | 55079 |

In some examples, the TI graph is a dynamic, time-evolving graph. Advantageously, the dynamic TI graph allows for more accurate risk score calculations based on current data and enables more efficient computing resource management by incorporating recent events and entities. To build the dynamic graph, a base graph is generated using a historical lookback window (e.g., a window of 24 hours). This window serves as the initial snapshot of the graph, representing key security events and relationships over the last day. Once the base graph is created, new data is incrementally added to the graph at fixed intervals (e.g., every 1-2 hours) using batch updates. This process of incrementally updating the graph offers significant computational advantages. For example, rather than loading an entire dataset spanning a longer time range (e.g., 7 days), the system 100 needs to process and integrate smaller batches of incoming data at smaller intervals thereby drastically reducing the load on memory and processing resources. This approach is particularly useful in environments with high telemetry volumes, where processing all data at once is computationally costly, or even infeasible.

Once the graph is updated with the latest data, the risk scores for nodes can be recalculated to reflect the evolving threat landscape. This dynamic updating allows the risk scores to adapt in near real-time to new information, improving the accuracy and relevance of reputation propagation algorithms. By continually updating the graph with fresh data (e.g., the telemetry data is received as a continuous data stream), risk assessments remain reflective of the most current security posture, providing a more responsive and agile approach to threat detection. For example, in the dynamic graph, each edge between nodes carries a weight that signifies the strength or relevance of the relationship between them. However, in a time-evolving system, older relationships (edges) may lose relevance as time progresses. To account for this, an edge weight decay function is introduced that automatically reduces edge weights based on the time elapsed since the edge was formed. For example, an IP address is linked to an alert for suspicious activity. Initially, the edge connecting the IP address node to the alert node has a high weight, reflecting the criticality of the connection. However, as time passes without further suspicious activity, the edge's weight decays. This decay can be particularly useful in prioritizing investigations, as it allows recent alerts with higher weights to stand out over older, less critical alerts.

As the graph evolves over time, certain nodes and edges may lose relevance due to decay or a lack of recent updates. To prevent the graph from becoming too large or cluttered with stale information, a pruning mechanism is implemented to remove nodes and edges when their edge weights fall below a certain threshold (e.g., when an edge's weight reaches 0 or near zero). The pruning process is based on one or more of the following: edge weight threshold and node relevance. For example, when the weight of an edge falls below a predefined threshold (e.g., 0), it is removed from the graph. This ensures that outdated or irrelevant relationships do not persist indefinitely, keeping the graph focused on more recent, meaningful connections. Nodes that are no longer connected to any other nodes (i.e., isolated nodes) can also be pruned. For example, if an entity no longer has any active connection to alerts or incidents, it can be removed from the graph to free up space and simplify analysis.

By pruning nodes and edges in this way, the graph is prevented from growing too large, which helps maintain its performance and scalability in addition to reducing processing and memory resources requirements for the system 100. This is particularly important in environments where the volume of incoming telemetry data is substantial. Pruning also reduces noise in the graph, enabling reputation propagation algorithms to focus on the most current and relevant data. For example, an IP address, that was previously associated with several alerts, has not been involved in any suspicious activity for several days. Over time, the weights of the edges connecting the IP address to those alerts will decay. Once the weights fall below the threshold, the edges can be pruned, and if the IP address is no longer connected to any other nodes, it can be removed as well. This process keeps the graph lean, ensuring that only recent and relevant entities are analyzed. In this way, dynamic time-evolving TI graphs, using time-decay functions and pruning of stale nodes and edges, not only improve the accuracy of risk scoring and reputation propagation algorithms but also provide a more agile framework for monitoring and responding to security threats.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, generating AI infused threat infrastructure profiling as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a user interface; a processor; and a memory comprising computer program code, the memory and the computer program code configured to cause the processor to: generate a threat intelligence (TI) graph on the user interface based on relationships in telemetry data, the TI graph comprising known entities and unknown entities; initialize risk scores for the known entities in the TI graph; classify, using a reputation propagation algorithm, one or more of the unknown entities based on relationships of the unknown entities with the known entities, and the risk scores for the known entities in the TI graph; recommend a remediation action for the classified unknown entities; automatically initiate the remediation action for the classified unknown entities; and in response to the remediation action, update the TI graph on the user interface.

An example computerized method comprises creating a threat intelligence (TI) graph based on relationships in telemetry data obtained from a database, the TI graph comprising known entities and unknown entities; initializing risk scores for the known entities in the TI graph from a TI database; classifying, using a reputation propagation algorithm, one or more of the unknown entities based on relationships of the unknown entities with the known entities, and the risk scores for the known entities in the TI graph; recommending a remediation action for the classified unknown entities; and automatically initiating the remediation action for the classified unknown entities.

A computer storage medium storing computer program code, that upon execution by a processor cause the processor to: create a dynamic threat intelligence (TI) graph based on relationships in telemetry data obtained from a database, the TI graph comprising known entities and unknown entities; initialize risk scores for the known entities in the TI graph from a TI database; classify, using a reputation propagation algorithm, one or more of the unknown entities based on relationships of the plurality of unknown entities with the known entities and the risk scores for the known entities in the TI graph; recommend a remediation action for the classified unknown entities; automatically initiate the remediation action for the classified unknown entities; based on the remediation action, identify a change in relationships between the known entities and the unknown entities; and updating the dynamic TI graph based on the identified change in relationships.

Alternatively, or in addition to the other examples described herein, examples include any combination of the following:
wherein the reputation propagation algorithm propagates threat actor labels to one or more of the unknown entities that are neighboring to the known entities, the threat actor labels being propagated at machine scale.
wherein edges in the TI graph have weights.
wherein weight of at least one of the edges in the TI graph is adjusted over time using an edge decaying weight function that indicates a rate of decay in the weight of the at least one of the edges in the TI graph.
wherein the edge decaying weight function is modelled by a different function of time for the edges in the TI graph based on edge relationships between different entities.
wherein the reputation propagation algorithm is a label propagation algorithm.
wherein the memory and the computer program code are configured to cause the processor to: identify an entity, from the classified unknown entities, having a high confidence level of the classification and that is not creating new downstream alerts; and based on the identification, automatically update one or more of: parameters of the reputation propagation algorithm, weights of nodes of the TI graph, or weights of edges of the TI graph.
wherein the memory and the computer program code are configured to cause the processor to: create a plurality of TI graphs for a plurality of geographic regions; and use a different reputation propagation algorithm for the plurality of TI graphs for the plurality of geographic regions.
wherein the memory and the computer program code are configured to cause the processor to: calculate an organizational level risk score for an organization based on an output of the TI graph, the organizational level risk score indicating how compromised an organization is.
wherein the memory and the computer program code are configured to cause the processor to: provide a triaging recommendation for the classified unknown entities, the triaging recommendation indicating whether the classification is true positive or false positive; and prioritize the remediation action for the classified unknown entities based on the triaging recommendation.
wherein the memory and the computer program code are configured to cause the processor to: receive a data stream of the telemetry data; and generate a dynamic TI graph by updating the TI graph as the data stream is received.
wherein the TI graph is generated for a first organization, wherein the memory and the computer program code are configured to cause the processor to: based on the TI graph for the first organization, initialize another TI graph for a second organization.
wherein the TI graph is a k-partite TI graph, wherein value of k is greater than 1.
wherein the k-partite TI graph includes entities comprising the known entities, the unknown entities, alerts, incidents, and organizations.
receiving an adaptive feedback from a customer, the adaptive feedback including an alert grade; and based on the adaptive feedback, initializing risk scores for the unknown entities in the TI graph.
wherein the computer program code causes the processor to: generate a logit for a node in the TI graph, the logit representing an unnormalized score for the node; scale the logit by applying temperature scaling; compute a calibrated probability using the scaled logit; determine an optimal temperature by minimizing a calibration loss of the computed calibrated probability; and based on the optimal temperature, produce calibrated probabilities for one or more nodes in the TI graph according to a true distribution of labels in a validation set.
wherein the computer program code causes the processor to: propagate, using the reputation propagation algorithm, one or more of the risk scores associated with the known entities to one or more of the unknown entities; and convert the propagated one or more of the risk scores into probabilistically interpretable scores for security researchers.
wherein the computer program code causes the processor to: propagate, using the reputation propagation algorithm, threat actor labels associated with the known entities to one or more of the unknown entities; and convert the propagated threat actor labels into probabilistically interpretable scores for security researchers.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for creating a TI graph based on relationships in telemetry data obtained from a database, the TI graph comprising known entities and unknown entities; exemplary means for initializing risk scores for the known entities in the TI graph from a TI database; exemplary means for classifying, using a reputation propagation algorithm, one or more of the unknown entities based on relationships of the unknown entities with the known entities, and the risk scores for the known entities in the TI graph; exemplary means for recommending a remediation action for the classified unknown entities; exemplary means for automatically initiating the remediation action for the classified unknown entities; and exemplary means for updating the TI graph in response to the remediation action.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a user interface;
a processor; and
a memory comprising computer program code, the memory and the computer program code configured to cause the processor to:
generate a threat intelligence (TI) graph on the user interface based on relationships in telemetry data, the TI graph comprising known entities and unknown entities;
initialize risk scores for the known entities in the TI graph;
classify, using a reputation propagation algorithm, one or more of the unknown entities based on relationships of the unknown entities with the known entities, and the risk scores for the known entities in the TI graph;
recommend a remediation action for the classified unknown entities;
automatically initiate the remediation action for the classified unknown entities; and
in response to the remediation action, update the TI graph on the user interface.

2. The system of claim 1, wherein the reputation propagation algorithm propagates threat actor labels to one or more of the unknown entities that are neighboring to the known entities, the threat actor labels being propagated at machine scale.

3. The system of claim 1, wherein edges in the TI graph have weights.

4. The system of claim 3, wherein weight of at least one of the edges in the TI graph is adjusted over time using an edge decaying weight function that indicates a rate of decay in the weight of the at least one of the edges in the TI graph.

5. The system of claim 4, wherein the edge decaying weight function is modelled by a different function of time for the edges in the TI graph based on edge relationships between different entities.

6. The system of claim 1, wherein the reputation propagation algorithm is a label propagation algorithm.

7. The system of claim 1, wherein the memory and the computer program code are configured to cause the processor to:
identify an entity, from the classified unknown entities, having a high confidence level of the classification and that is not creating new downstream alerts; and
based on the identification, automatically update one or more of: parameters of the reputation propagation algorithm, weights of nodes of the TI graph, or weights of edges of the TI graph.

8. The system of claim 1, wherein the memory and the computer program code are configured to cause the processor to:
create a plurality of TI graphs for a plurality of geographic regions; and
use a different reputation propagation algorithm for the plurality of TI graphs for the plurality of geographic regions.

9. The system of claim 1, wherein the memory and the computer program code are configured to cause the processor to:
calculate an organizational level risk score for an organization based on an output of the TI graph, the organizational level risk score indicating how compromised an organization is.

10. The system of claim 1, wherein the memory and the computer program code are configured to cause the processor to:
provide a triaging recommendation for the classified unknown entities, the triaging recommendation indicating whether the classification is true positive or false positive; and
prioritize the remediation action for the classified unknown entities based on the triaging recommendation.

11. The system of claim 1, wherein the memory and the computer program code are configured to cause the processor to:
receive a data stream of the telemetry data; and
generate a dynamic TI graph by updating the TI graph as the data stream is received.

12. The system of claim 1, wherein the TI graph is generated for a first organization, wherein the memory and the computer program code are configured to cause the processor to:
based on the TI graph for the first organization, initialize another TI graph for a second organization.

13. A computerized method comprising:
creating a threat intelligence (TI) graph based on relationships in telemetry data obtained from a database, the TI graph comprising known entities and unknown entities;
initializing risk scores for the known entities in the TI graph from a TI database;
classifying, using a reputation propagation algorithm, one or more of the unknown entities based on relationships of the unknown entities with the known entities, and the risk scores for the known entities in the TI graph;
recommending a remediation action for the classified unknown entities; and
automatically initiating the remediation action for the classified unknown entities.

14. The method of claim 13, wherein the TI graph is a k-partite TI graph, wherein value of k is greater than 1.

15. The method of claim 14, wherein the k-partite TI graph includes entities comprising the known entities, the unknown entities, alerts, incidents, and organizations.

16. The method of claim 13, further comprising:
receiving an adaptive feedback from a customer, the adaptive feedback including an alert grade; and
based on the adaptive feedback, initializing risk scores for the unknown entities in the TI graph.

17. A computer storage medium storing computer program code, that upon execution by a processor cause the processor to:
create a dynamic threat intelligence (TI) graph based on relationships in telemetry data obtained from a database, the TI graph comprising known entities and unknown entities;
initialize risk scores for the known entities in the TI graph from a TI database;
classify, using a reputation propagation algorithm, one or more of the unknown entities based on relationships of the plurality of unknown entities with the known entities and the risk scores for the known entities in the TI graph;
recommend a remediation action for the classified unknown entities;
based on the remediation action, identify a change in relationships between the known entities and the unknown entities; and
updating the dynamic TI graph based on the identified change in relationships.

18. The computer storage medium of claim 17, wherein the computer program code causes the processor to:
generate a logit for a node in the TI graph, the logit representing an unnormalized score for the node;
scale the logit by applying temperature scaling;
compute a calibrated probability using the scaled logit;
determine an optimal temperature by minimizing a calibration loss of the computed calibrated probability; and
based on the optimal temperature, produce calibrated probabilities for one or more nodes in the TI graph according to a true distribution of labels in a validation set.

19. The computer storage medium of claim 17, wherein the computer program code causes the processor to:
propagate, using the reputation propagation algorithm, one or more of the risk scores associated with the known entities to one or more of the unknown entities; and
convert the propagated one or more of the risk scores into probabilistically interpretable scores for security researchers.

20. The computer storage medium of claim 17, wherein the computer program code causes the processor to:
propagate, using the reputation propagation algorithm, threat actor labels associated with the known entities to one or more of the unknown entities; and
convert the propagated threat actor labels into probabilistically interpretable scores for security researchers.
